(19) United States
(12) Patent Application Publication
(10) Pub. No.: US 2022/0116744 A1
(43) Pub. Date: Apr. 14, 2022

(54) Efficient Beam Pattern Feedback in Millimeter Wave Positioning Systems

(71) Applicant: QUALCOMM Incorporated, San Diego, CA (US)

(72) Inventors: Vasanthan RAGHAVAN, West Windsor Township, NJ (US); Sony AKKARAKARAN, Poway, CA (US); Juergen CEZANNE, Ocean Township, NJ (US)

(21) Appl. No.: 17/483,245

(22) Filed: Sep. 23, 2021

Related U.S. Application Data
(60) Provisional application No. 63/091,034, filed on Oct. 13, 2020.

(51) Int. Cl. H04W 4/029; G01S 5/00; G01S 5/08

(52) U.S. Cl. CPC H04W 4/029; G01S 5/08; G01S 5/0036

(57) ABSTRACT

Embodiments described herein provide efficient beam pattern feedback from a user equipment (UE) to a receiving device to help reduce overhead of providing beam pattern information for position determination while maintaining high position determination accuracy. Embodiments include providing beam weights and template elemental game patterns, an elemental gain formula and parameters, and/or template beam patterns with boresight to a remote device, enabling the remote device to determine beam shape.

### RELATED APPLICATIONS

This application claims the benefit of U.S. Provisional Application No. 63/091,034, filed Oct. 13, 2020, entitled “EFFICIENT BEAM PATTERN FEEDBACK IN MILLIMETER WAVE POSITIONING SYSTEMS”, which is assigned to the assignee hereof, and incorporated herein in its entirety by reference.

### BACKGROUND

### 1. Field of Disclosure

The present disclosure relates generally to the field of wireless communications, and more specifically to determining the location of a User Equipment (UE) using radiofrequency (RF) signals.

### 2. Description of Related Art

In a data communication network, various positioning techniques can be used to determine the location of a mobile electronic device (referred to herein as a user equipment or a UE). Some of these positioning techniques may involve determining angular information of beams used by the UE transmit or receive paths that use one or more RF signals. For example, information regarding the beam pattern or beam shape used by a UE to transmit RF signals received by one or more Transmission Reception Points (TRPs) can be used to measure Angle of Departure (AOD) information. Additionally or alternatively, the beam shape used by the UE to receive RF signals transmitted by one or more TRPs can be used to measure Angle of Arrival (AOA) information. Either or both of these types of measurements, together with information regarding the location of the one or more TRPs, can be used to determine a location of the UE.

### BRIEF SUMMARY

Embodiments described herein provide efficient beam pattern feedback from a user equipment (UE) to a receiving device to help reduce overhead of providing beam pattern information for position determination while maintaining high position determination accuracy. Embodiments include providing beam weights and template elemental game patterns, an elemental gain formula and parameters, and/or template beam patterns with boresight to a remote device, enabling the remote device to determine beam shape.

An example method at a mobile device of providing beam pattern information of a beam used by a separate device for position determination of the mobile device, according to this disclosure, may comprise determining a use of the beam in a transmission or reception of a reference signal by the mobile device. The method also may comprise, responsive to the determining the use of the beam, sending, from the mobile device to the separate device, the beam pattern information, wherein the beam pattern information comprises information indicative of: an elemental gain pattern in E_{Θ} and E_{Φ} polarizations, or in E and H planes, of at least one antenna element of the mobile device. The method also may comprise a boresight of the beam and a template beam pattern.

An example mobile device for providing beam pattern information of a beam used by a separate device for position determination of the mobile device, according to this disclosure, may comprise a transceiver, a memory, one or more processors communicatively coupled with the transceiver and the memory, wherein the one or more processors are configured to determine a use of the beam in a transmission or reception of a reference signal by the mobile device. The one or more processors further may be configured to responsive to the determining the use of the beam, sending, via the transceiver to the separate device, the beam pattern information, wherein the beam pattern information comprises information indicative of: an elemental gain pattern in E_{Θ} and E_{Φ} polarizations, or in E and H planes, of at least one antenna element of the mobile device. The one or more processors further may be configured to a boresight of the beam and a template beam pattern.

An example apparatus for providing beam pattern information of a beam used by a separate device for position determination of the apparatus, according to this disclosure, may comprise means for determining a use of the beam in a transmission or reception of a reference signal by the apparatus. The apparatus further may comprise means for, responsive to the determining the use of the beam, sending, from the apparatus to the separate device, the beam pattern information, wherein the beam pattern information comprises information indicative of: an elemental gain pattern in E_{Θ} and E_{Φ} polarizations, or in E and H planes, of at least one antenna element of the apparatus. The apparatus further may comprise a boresight of the beam and a template beam pattern.

According to this disclosure, an example non-transitory computer-readable medium stores instructions for providing beam pattern information of a beam used by a separate device for position determination of a mobile device, the instructions comprising code for determining a use of the beam in a transmission or reception of a reference signal by the mobile device. The instructions further may comprise code for, responsive to the determining the use of the beam, sending, from the mobile device to the separate device, the beam pattern information, wherein the beam pattern information comprises information indicative of: an elemental gain pattern in E_{Θ} and E_{Φ} polarizations, or in E and H planes, of at least one antenna element of the mobile device. The instructions further may comprise code for a boresight of the beam and a template beam pattern.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5G NR positioning system, according to an embodiment.

FIG. 3 illustrates a simplified environment in which beamforming is used, according to an embodiment.

FIG. 4 is a graphical representation of an embodiment of a downlink (DL) angle of departure (AOD) (DL-AOD) process in which angular information provided by beams can be used to determine the position of a user equipment (UE).

FIG. 5 is a graphical representation of an embodiment of an uplink (UL) AOD (UL-AOD) process.

FIG. 6 is a graph that plots a cosine approximation of elemental gain for measured data with a form factor antenna element at 28 GHz.

FIG. 7 is an example of different template beam patterns.

FIG. 8 is a flow diagram of method of providing beam pattern information of a beam used by a mobile device to a second device for position determination of the mobile device, according to an embodiment.

FIG. 9 is a block diagram of a UE, according to an embodiment.

FIG. 10 is a block diagram of a Transmission/Reception Point (TRP), according to an embodiment.

FIG. 11 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

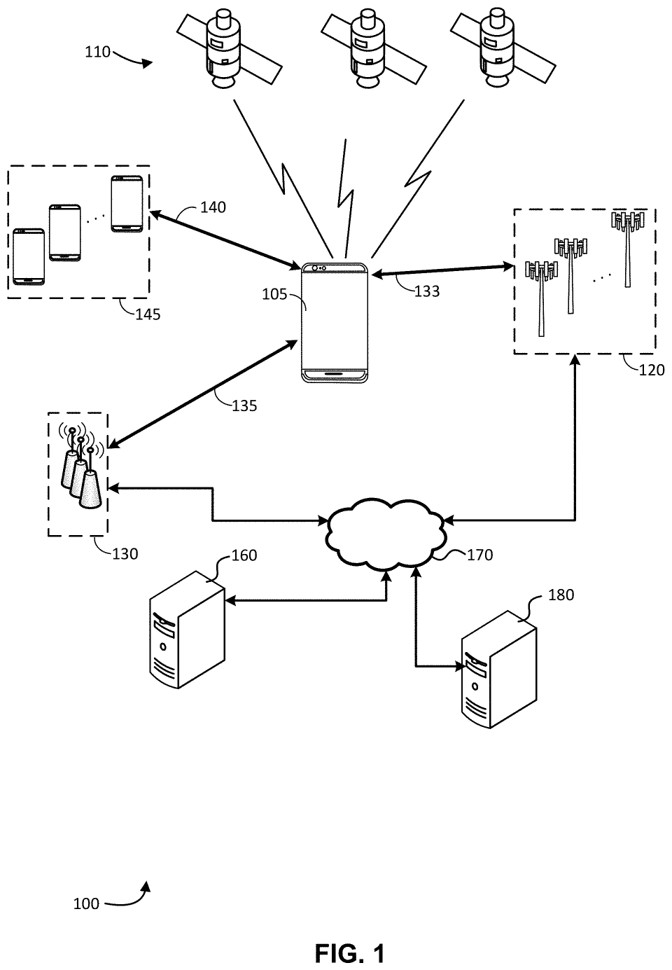

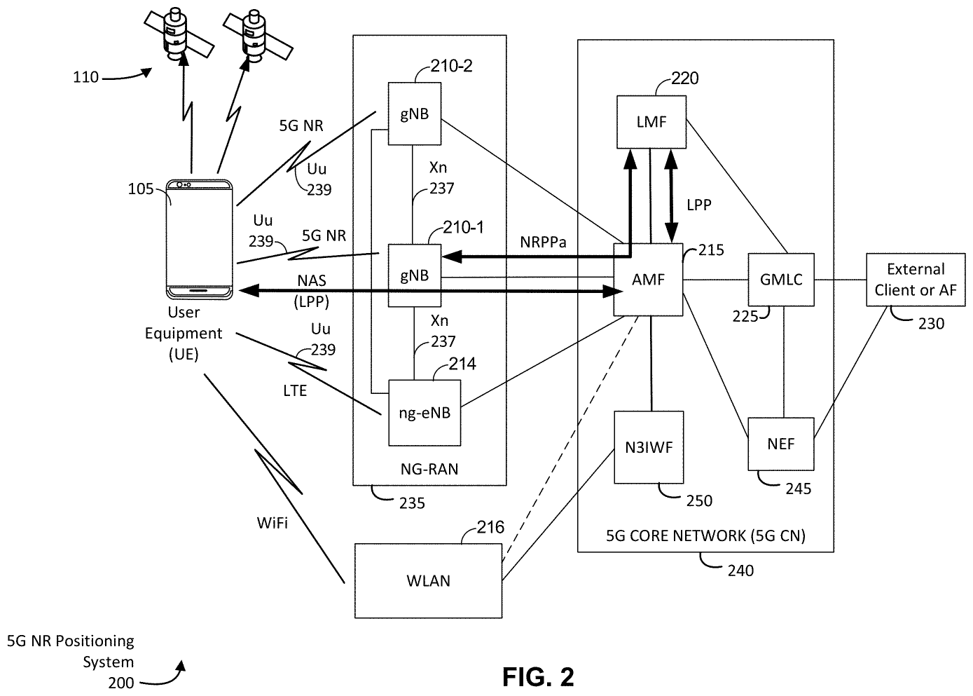

FIG. 1 is a simplified illustration of a positioning system 100 in which a UE 105, location server 160, and/or other components of the positioning system 100 can use the techniques provided herein for determining an estimated location of UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, asset tracking or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), tracking device, navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AOA), angle of departure (AOD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230. The GMLC 225 is shown connected to both the AMF 215 and LMF 220 in FIG. 2 though only one of these connections may be supported by 5G CN 240 in some implementations.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AOD, and/or ECID. The NRPPa protocol may be used to support positioning of UE 105 using network based position methods such as ECID, AOA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AOA, Receive Time-Transmission Time Difference (Rx-Tx), Differential AOA (DAOA), AOD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AOA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

In a 5G NR positioning system 200, some location measurements taken by the UE 105 (e.g., AOA, AOD, TOA) may use RF reference signals received from base stations (e.g., gNBs 210 and ng-eNB 214). As described in detail below, such signals may comprise PRS, which can be used, for example, to execute OTDOA, AOD, and RTT-based positioning of the UE 105. Other reference signals that can be used for positioning.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AOD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AOD and/or AOA.

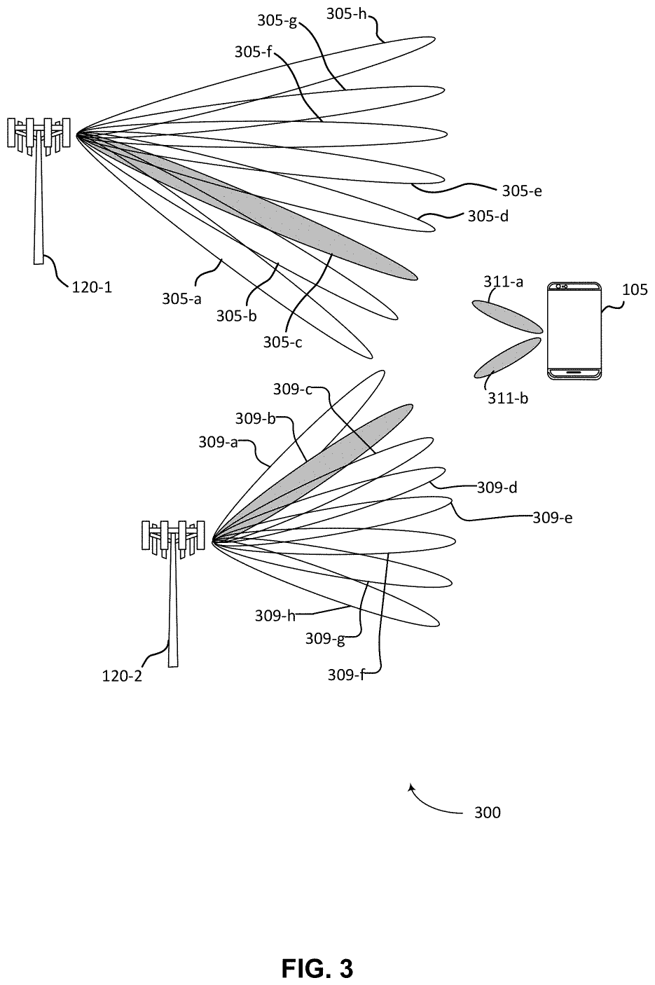

FIG. 3 by way of example, illustrates a simplified environment 300 including two base stations 120-1 and 120-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a base station 120 base station 120 to correspond with different areas within a coverage area for the base station 120.

Different modes of operation may enable base stations 120-1 and 120-2 to use a larger or smaller number of beams. For example, in a first mode of operation, a base station 120 may use 16 beams, in which case each beam may have a relatively wide beam width. In a second mode of operation, a base station 120 may use 64 beams, in which case each beam may have a relatively narrow beam width. Depending on the capabilities of a base station 120, the base station may use any number of beams the base station 120 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 120 may use beam sweeping. Beam sweeping is a process in which the base station 120 may send an RF signal in different directions using different respective beams, often in succession, effectively “sweeping” across a coverage area. For example, a base station 120 may sweep across 120 or 360 degrees in an azimuth direction, for each beam sweep, which may be periodically repeated. Each direction beam can include an RF reference signal (e.g., a PRS resource), where base station 120-1 produces a set of RF reference signals that includes Tx beams 305-a, 305-b, 305-c, 305-d, 305-e, 305-f, 305-g, and 305-h, and the base station 120-2 produces a set of RF reference signals that includes Tx beams 309-a, 309-b, 309-c, 309-d, 309-e, 309-f, 309-g, and 309-h. Because UE 105 may also include an antenna array, it can receive RF reference signals transmitted by base stations 120-1 and 120-2 using beamforming to form respective receive beams (Rx beams) 311-a and 311-b. Beamforming in this manner (by base stations 120 and optionally by UEs 105) can be used to make communications more efficient. They can also be used for other purposes, including taking measurements for position determination (e.g., AOD and AOA measurements).

The selection of beam 305-c from base station 120-1 can be from a receive-side beam sweeping operation in which UE 105 determines the RF reference signal (e.g., using reference signal receive power (RSRP)) is the highest (among all Tx beam 305 and Rx beam 311 combinations) for a beam pair comprising a Tx beam 305-c and Rx beam 311-a. A similar process can be used to determine beam pair 309-b and 311-b. In this manner the beam pairs illustrated with shading in FIG. 3 can be used for taking position-related measurements to determine the location of the UE 105.

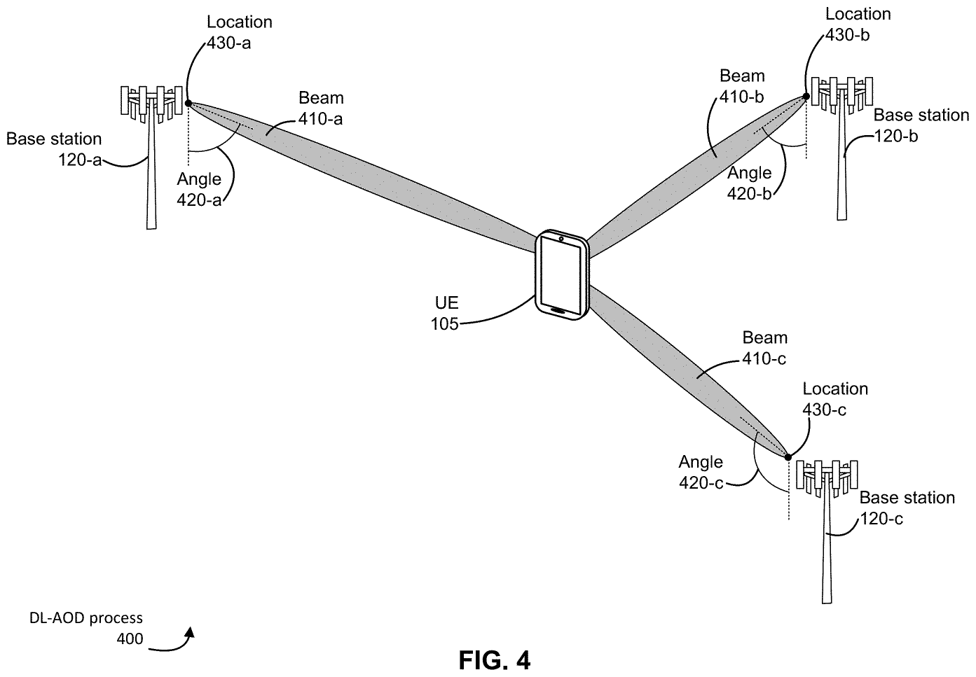

Traditionally, the use of beams in the determination of the location of the UE 105 has fallen largely on the beams of the base stations 120 (TRPs). This is because base stations 120 typically do not face the same limitations with regard to power usage or the number of antenna elements, allowing base stations 120 to have a relatively large number of beams, resulting in higher angular resolution (relative to a UE 105) for positioning. FIG. 4 provides an example of how base station beams may be used in this manner.

FIG. 4 is a graphical representation of an embodiment of a downlink AOD (DL-AOD) process 400 in which angular information provided by beams 410 can be used to determine the position of a UE 105. It can be noted, however, that embodiments for providing beam information (described in more detail below) are not limited to such processes. Other embodiments may include additional or alternative types of measurements and/or positioning processes.

In FIG. 4, base stations 120-a, 120-b, and 120-c transmitted respective RF reference signals using respective beams 410-a, 410-b, and 410-c. The UE 105, as noted, can make RSRP measurements of the respective RF reference signals, which can be used to determine respective DL-AODs. In some embodiments, for example in network-based positioning, the UE 105 may communicate RSRP measurements to a location server to determine the DL-AODs. In other embodiments, for example in UE-based positioning, the UE 105 may determine the DL-AODs. The DL-AODs (corresponding to angles 420-a, 420-b, and 420-c) may be with respect to a reference direction or plane. The DL-AODs can then be used, together with base station locations 430-a, 430-b, and 430-c to triangulate the position of the UE 105. It can be noted, that in other instances or embodiments, a different number of base stations 120 may be used to determine the location of the UE 105. Moreover, in some embodiments, distance measurements may be used (e.g., a distance between the UE 105 and one or more base stations 120, as measured, for example, using RTT) in addition to DL-AOD information to calculate the position of the UE 105.

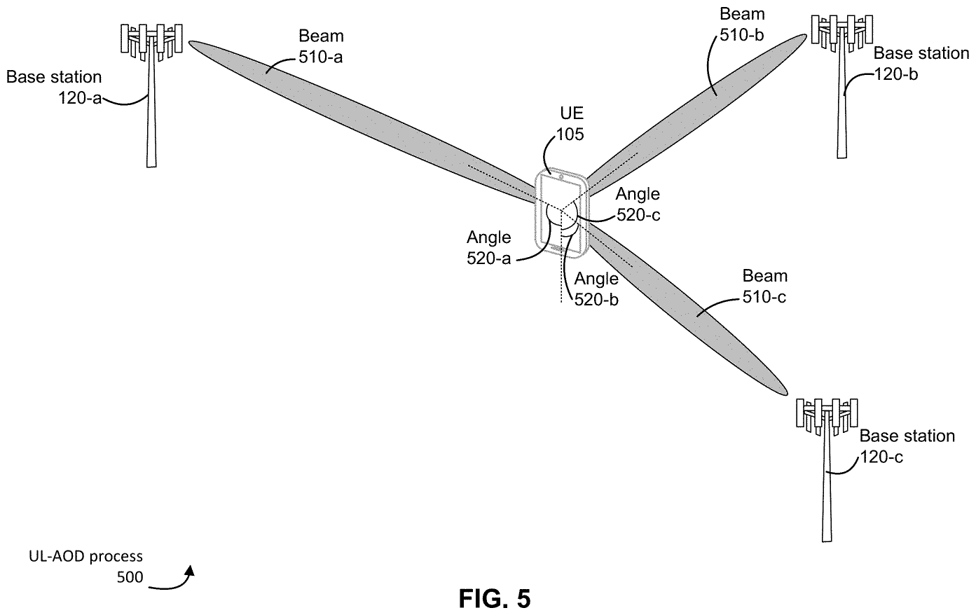

As previously noted, beam resolution has traditionally been much higher on base stations 120 than on UEs 105, due to the larger antenna arrays that base stations 120 typically have. However, as increasingly higher RF frequencies are used, more antenna elements can be used over the same aperture as inter-antenna element spacings are maintained at half a wavelength of transmissions. Due to the use of larger antenna arrays on a UE 105, the UE can form beams of a higher resolution. For example, frequency bands in frequency range 4 (FR4), which may be called “upper millimeter wave bands” or “sub-THz regime,” span from 52.6 GHz to 114.25 GHz. Because these bands are significantly higher than those in FR2 (which span from 24.25 GHz to 52.6 GHz), it is possible to include many more antenna elements in the same physical aperture for use in FR4 than at FR2 (e.g., an array of 4×1, 8×2, or 16×4 or more could be used.) Thus, the use of a UL-AOD process 500 as illustrated in FIG. 5 in such circumstances can provide high accuracy and is attracting more attention as a feasible way in which the position of the UE 105 can be determined.

FIG. 5 is a graphical representation of an uplink AOD (UL-AOD) process 500, according to an embodiment. Similar to the DL-AOD process 400 of FIG. 4, the UL-AOD process 500 uses angular information provided by beams 510 to determine the position of a UE 105. Here, however, the beams 520 are transmit beams used by the UE 105 to transmit reference signals (e.g., uplink PRS (UL-PRS)) at angles 520 received by the base stations 120. (It can be noted that, for simplicity, the angles 520 of FIG. 5 are portrayed as being angles from an arbitrary direction or plane. In practice, angles may be determined using relative and/or absolute coordinates, using any of a variety of coordinate systems such as the global or local coordinate systems.) As with FIG. 4, FIG. 5 is provided as a non-limiting example. Embodiments may make UL-AOD measurements using any number of base stations, in a variety of locations band/or distributions relative to the UE 105.

Put briefly, the UE 105 transmits RF reference signals on beams 510-a, 510-b, and 510-c, which are respectively received by base stations 120-a, 120-b, and 120-c. The base stations 120, can make RSRP measurements of the respective RF reference signals, which can be used to determine respective UL-AODs (angles 520-a, 520-b, and 520-c. As with positioning based on DL-AODs, the UL-AODs can then be used with base station locations to triangulate the position of the UE 105 (e.g., based on angles alone) or used to complement other types of position determination to improve accuracy.

Some networks additionally or alternatively may be configured to perform downlink AOA (DL-AOA) measurements. In such instances, base stations 120 transmit RF reference signals in a process similar to the DL-AOD process 400 described with respect to FIG. 4. However, the UE 105 can use various receive beams to receive the transmitted RF reference signals. Similar to the transmit beams 510 illustrated in FIG. 5, the angle of the receive beams at the UE 105 used to receive the RF reference signals, along with measurements (e.g., RSRP measurements) of the RF reference signals from the base stations 120, can be used to determine the angles 520, and ultimately the position of the UE. Again, DL-AOD can be used for triangulation and/or other types of position determination methods.

For both UL-AOD and DL-AOA, in which the beams of the UE 105 are used, the determination of the position of the UE 105 may be “UE-assisted.” In other words, measurements made by the UE can then be provided to the network (e.g., to LMF 220 or an intermediate location determination function), enabling the network to use the measurements to determine the UEs position. It can be noted that, although a base station 120 might not determine the location of the UE 105, the entity that determines the position of the UE (e.g., LMF 220 or other function) may be co-located with the base station 120. This UE-assisted functionality can be burdensome in many cases because not only may the UE 105 need to provide measurement information (e.g., RSRP measurements in the case of DL-AOA), but also information regarding the shape of the beam used to receive or transmit a reference signal. (In UL-AOD, for example, a knowledge of the beam shape can be enabled for determination of whether a receiving base station 120-a receives a UL-PRS via the main lobe of the corresponding beam 510-a, or side lobe.) This is because beam shape can vary from one type of UE 105 to the next, are often proprietary, and further can be dependent on dynamic characteristics (e.g., temperature, frequency, etc.). Providing beam shape information to a network entity sufficient to determine a high accuracy of a beam angle 520 (e.g., within 0.1° in azimuth and/or elevation) can require a lot of overhead, especially when providing positioning over such a relatively large bandwidth with a UE 105 having multiple antenna modules.

Embodiments described herein provide efficient beam pattern feedback to help reduce the feedback overhead while maintaining high position determination accuracy. Embodiments include providing beam weights and template elemental gain patterns, an elemental gain formula and parameters, and/or template beam patterns with boresight (or steered to other angles) to a remote device, enabling the remote device to determine beam shape. As noted, the receiving device may comprise an LMF 220, but embodiments are not so limited. As previously noted, other devices and/or functions of a communication network may be used to determine the location of the UE 105.

Because ideal beam patterns across spatial angles and frequencies can be computed using beam weights and inter-antenna element spacings, one embodiment may include the UE 105 providing an indication to the receiving device of an indication of beam weights used in the creation of a beam 510. Because computed ideal beam patterns based on beam weights and inter-antenna element spacings, may suffer inaccuracy due to UE design features, some embodiments may include providing template elemental gain patterns (e.g., as provided in applicable 3GPP standards) in addition to ideal beam patterns to compute actual array gain variations over space and frequency. One drawback of this approach, however, is that it may suffer from relatively poor accuracy for smaller arrays that may be used by the UE 105. Thus, the resulting beam determination may be inaccurate in terms of array gain estimate over spatial angles.

Alternatively, according to another approach, the elemental gain pattern of a subset of antenna elements can be provided. In such embodiments, the UE may provide space- and/or frequency-varying elemental gain patterns in EΘ and EΦ polarizations (or in E and H planes) for one or more antenna elements in the antenna array of the UE 105 to allow the receiving device (e.g., LMF) to determine the full beam pattern for the UE 105. As a person of ordinary skill in the art will appreciate, the E plane is a term of art for the plane in which the electric filed is dominant. Similarly, the H plane is a term of art for the plane in which the magnetic field is dominant. EΘ and EΦ polarizations, too, are terms of art referring to radiation in a spherical coordinate system. Depending on desired functionality (including desired accuracy) the level of quantization for the elemental gain pattern may vary (e.g., 0.1°, 0.5°, 1°, 2°, 5°, etc.). To further reduce the amount of information used to convey the elemental gain pattern, the UE 105 may instead convey descriptive aspects of elemental gain pattern such as peak gain, beamwidth at different offset gain values (e.g., 3 dB beamwidth, 5 dB beamwidth, 10 dB beamwidth, etc.) from peak gain as a function of frequency (for some sample frequencies). Again, the level of quantization for these descriptive values can vary, depending on desired functionality. This can result in significantly reduced overhead for providing the beam pattern, although accuracy is dependent on quantized sets of data.

Although the approaches above can be helpful in reducing the amount of overhead, they have their drawbacks. As noted, the accuracy of the resulting position determination for the UE be limited due to limited applicability of modeling to smaller arrays and/or limited amount of data in a quantized data set. Thus, according to embodiments herein, alternative approaches may be used to provide a more complete, more accurate description of a beam pattern.

According to one approach, a parametric functional formula that fits the elemental gain for a UE 105 as a function of spatial can be determined, and the UE can provide the corresponding parameters for the formula to the receiving device (along with beam weights and inter-antenna element spacings) for determination of the beam pattern. In this approach, the parametric formula used may approximate elemental gain across frequency and angle, and offer a first order approximation for elemental gain. An example formula is as follows:

Elemental gain(f,θ)=A(f)*cos(θ)^{1.5} (1)

Here, A(f) is a gain factor as a function of frequency f. Other parametric formulas based on patch/dipole or other antenna types also may be used. Different types/classes of UEs 105 may utilize different parametric formulas.

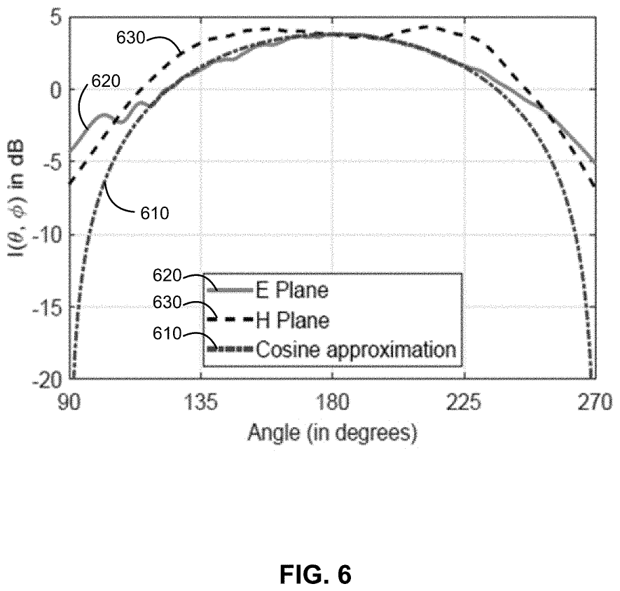

FIG. 6 is a graph that plots a cosine approximation (formula (1)) of elemental gain for measured data with a form factor antenna element at 28 GHz. As can be seen, the cosine approximation 610 provides an accurate first order approximation for E plane 620 and H plane 630 gain values. According to embodiments, true E plane 620 and H plane 630 elemental gain for a given device can be determined by a manufacturer of the device (e.g., in an anechoic chamber) in different conditions (e.g., across different frequencies, temperatures, etc.), and parameters for the parametric formula used to best approximate true elemental gain in the different conditions can be determined and stored in a lookup table. For example, the exponent for the cos(θ) term may be 1.5 at one frequency, 1.4 at another, and 1.6 at yet another. Differences between the parametric formula and true elemental gain can be coarsely quantized with fewer bits and fed back along with A(f). In some embodiments, the receiving device (e.g., LMF) may know the parametric formula a priori (e.g., if provided via a governing standard or a local/regional regulatory body), or the formula may be provided by the UE 105. In either case, the UE can provide relevant parameters to the receiving device for current and/or expected conditions, enabling the receiving device to determine the elemental gain pattern and beam pattern used by the UE 105. Parameters for formula (1) can include, for example, the gain factor A(f) for different conditions (frequencies, temperature, etc.). If the exponent also varies under different conditions, it may also be provided. The parameters can be provided by the UE prior to a positioning session with an LMF, for example, based on anticipated or expected conditions (frequency, temperature, etc.). Additionally or alternatively, parameters may be provided during and/or after a positioning session. As noted, the parameters can be provided with the beam weights used by the UE 105 and the inter-antenna element spacings of the UE 105 for determination of the beam pattern. In some embodiments, if inter-antenna element spacing is not provided, it may be assumed that inter-antenna element spacing is λ/2.

In some embodiments, parameters provided for commonly-used frequencies and/or sample points that span a frequency range. For the 57-71 GHz frequency range, for example, sample points could be provided at 57 GHz, 64 GHz, and 71 GHz. Alternatively, sample points could be given in 1 GHz increments across the entire frequency range (e.g., from 57 GHz to 71 GHz). In some embodiments, temperature may be provided in a similar fashion, using expected temperatures/temperature ranges, with a number of sample points dependent on desired functionality. (The UE 105 can measure and send the actual temperature at the time the beam 510 is used at the receiving device to ensure an accurate beam pattern determination by the receiving device.)

Although standardization of information communicated by the UE such as parametric formulas and parameters may not ultimately be used, the indexing of information based on standardization or otherwise predetermined values may allow for further efficiency. That is, different parametric formulas may be indexed to values in a lookup table used in a governing/regulatory standard or otherwise agreed upon by the UE 105 and the receiving device. In such instances, the UE 105 may simply need to provide the index number for the corresponding value, and the receiving device may use the index number to determine the proper value (e.g., parametric formula). In some embodiments, there may be different lookup tables for different classes of devices. For certain types of UEs (e.g., mobile phones) there may be a broad array of different classes, and standardization of parametric formulas or other information reflective of the beam pattern may not be an eventuality. However, for simpler devices (e.g., wearables, IOT devices, etc.) standardization of beam-pattern-related information may be more likely.

The timing and/or frequency with which this information regarding beam pattern is provided by the UE 105 to the receiving device may vary, depending on desired functionality. As noted, in some embodiments, the UE 105 may provide this information to an LMF 220 prior to and/or at the beginning of each positioning session with the LMF 220. In other embodiments, the UE 105 may provide this information periodically (e.g., every X seconds) and/or upon detecting a triggering condition (e.g., a temperature change of a threshold amount).

According to another embodiment, both the UE 105 and the receiving device may have a common codebook of template beam patterns. Rather than provide beam weights and parameters to the receiving device to compute the beam pattern, the UE 105 can instead reference the template beam pattern used to send or receive the reference RF signal. The receiving device can then use the codebook to identify the beam pattern and determine the location of the UE 105 based on the identified pattern.

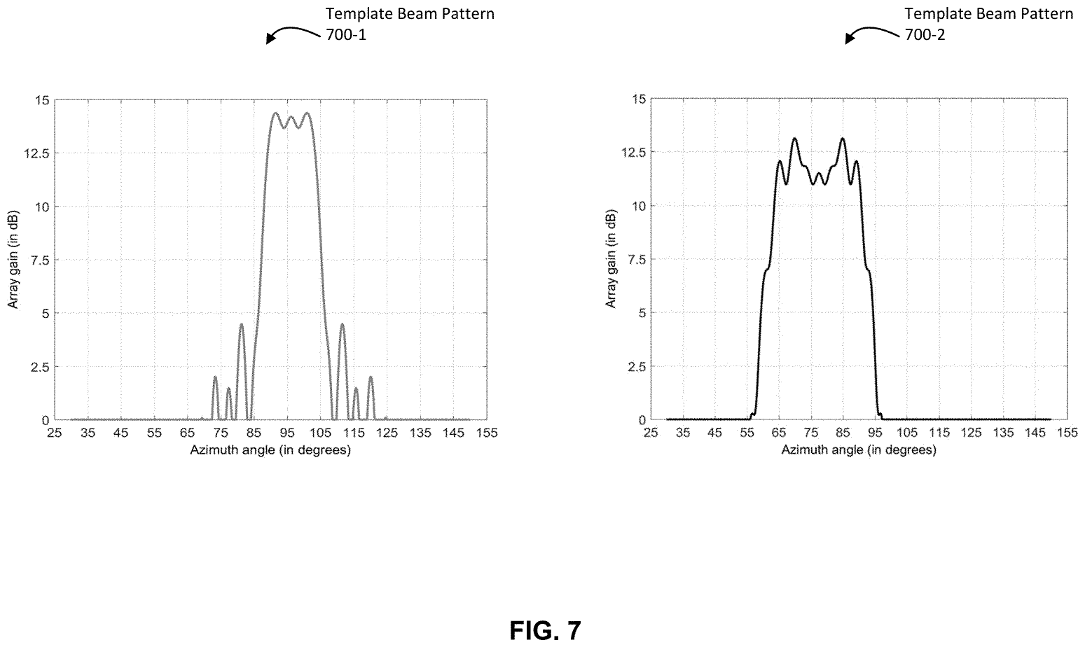

FIG. 7 is an example of different template beam patterns 700-1 and 700-2 (collectively and generically referred to herein as template beam patterns 700). As illustrated, various aspects of the template beam patterns 700 may vary, including angle, gain, and width. Thus, having a common codebook with multiple template beam patterns 700, the UE 105 can simply provide the receiving device with a value indicative of the template beam pattern 700 used (e.g., an index number) and the receiving device can easily identify the corresponding beam pattern.

The acquisition of the codebook by the receiving device can vary, depending on desired functionality. In some embodiments, the codebook of template beam patterns may be standardized, in which case the receiving device can simply reference the standard to obtain the appropriate template beam pattern 700. Additionally or alternatively, the codebook may be provided to the receiving device by the UE 105. Because template beam patterns 700 are static, this can be done once, such as registering with the remote device (e.g., at startup of the UE 105 and/or when the UE 105 registers with the mobile communication network). After this initial data transfer (which may be a large amount of data if the codebook may include many template beam patterns 700) the UE 105 can simply provide an identifier (e.g., index number) for the template beam pattern 700 used.

For beams used by the UE 105 to transmit reference RF signals (e.g., for UL-AOD), the UE can further provide the boresight angle for the beam. Boresight angle, which is a function of frequency, can be determined by the UE 105 using a lookup table that provides the corresponding boresight for the frequency used. When the boresight angle is provided to the receiving device and the template beam pattern 700 is identified to the receiving device, the receiving device can then accurately identify the beam pattern used.

In instances in which there are differences between the beam pattern used and the template beam pattern 700, the UE 105 may indicate these differences to the receiving device. For example, specific tolerance levels or uncertainties in terms of deviation from the template beam pattern 700 with actual transmit (Tx) and receive (Rx) patterns can be conveyed by the UE. Additionally or alternatively, if there is uncertainty with regard to the actual Tx/Rx beam pattern used by the UE 105, the UE 105 can convey this uncertainty (e.g., in percentage or dB or in terms of different percentage points of the CDF curve) to the receiving device. These tolerances and/or uncertainties in the beam pattern can be carried through to the position determination, indicated as tolerances and/or uncertainties in the resulting position determination.

Finally, as a brief example of how information may be conveyed from the UE 105 to receiving device (e.g., LMF 220), the following type of format can be used in the radio resource control (RRC) information element (IE) for the UE 105:

```
  antennaElementalGainPattern ::= CHOICE {
  antennaElementalGainPatternExplicit
    /* this could be the 2D array of gain distribution of E_{Θ} and E_{Φ} as a
function of elevation and azimuth angles, θ and φ */
  antennaElementalGainPatternParameterized
  }
  antennaElementalGainPatternParameterized ::= CHOICE {
  Representation1 ParametricRepresentation1
  Representation2 ParametricRepresentation2
  ...
  }
  Representation1 = SEQUENCE {
  FreqSamples INTEGER (0..maxINT-Freq-Samples)
  FreqValues ENUMERATED { Val1..ValN }
  antennaElementalGainError1 }
```

In this example, information provided by the UE may comprise an explicit description of gain distribution (in a 2D array) of the beam or a parameterized description of the gain distribution of the beam.

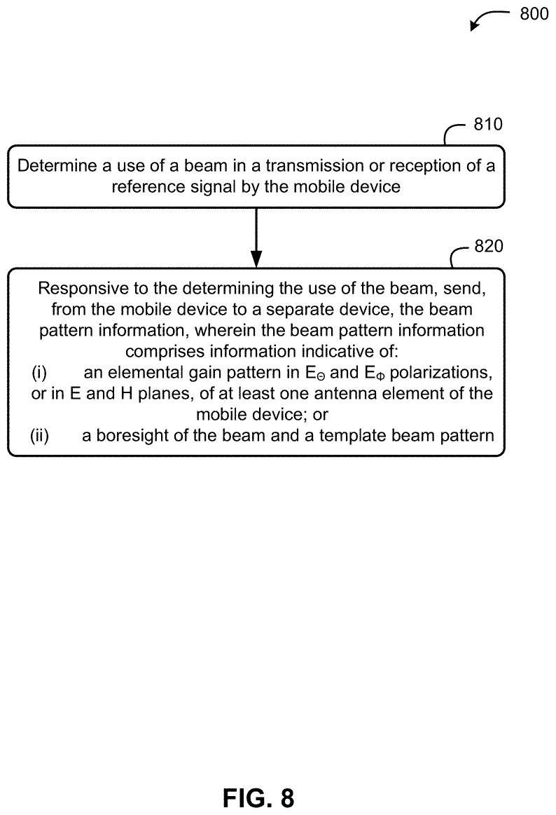

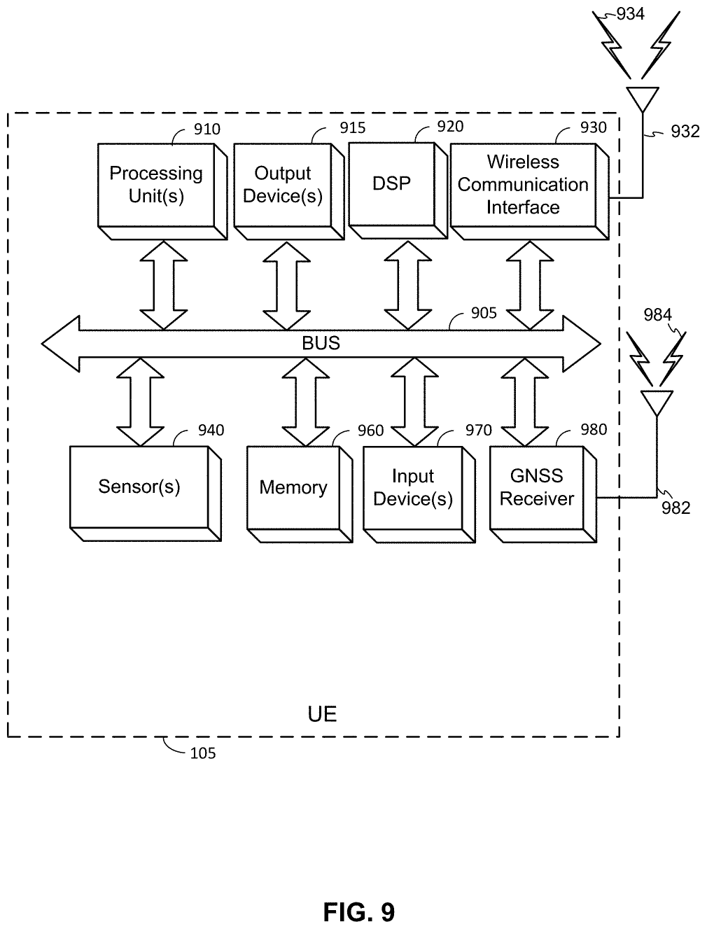

FIG. 8 is a flow diagram of method 800 of providing beam pattern information of a beam used by a mobile device to a separate device for position determination of the mobile device, according to an embodiment. As noted in the embodiments above, the mobile device may comprise a UE. That said, according to some embodiments, the method 800 may be performed by any beamforming device. The separate device may comprise a network node configured to determine the location of the UE. Means for performing the functionality illustrated in the blocks shown in FIG. 8 may be performed by hardware and/or software components of a UE. Example components of a UE are illustrated in FIG. 9, which is described in more detail below.

At block 810, the functionality comprises determining a use of a beam and a transmission or reception of a reference signal by the mobile device. As described in the embodiments above, the beam may comprise a Tx beam for UL-AOD measurements of a reference signal transmitted by the mobile device or an Rx beam used by the mobile device for DL-AOA measurements of a reference signal transmitted by another device (e.g., a TRP) and received at the mobile device. Depending on whether block 810 is performed before or after the use of the beam, the determination of the use of the beam may comprise determining to use the beam or determining that the beam was used, depending on the scenario. Means for performing functionality at block 810 may comprise a wireless communication interface 930, bus 905, processing unit(s) 910, memory 960, and/or other components of a UE 105, as illustrated in FIG. 9.

At block 820, the functionality comprises, responsive to the determining the use of the beam, sending, from the mobile device to the separate device, the beam pattern information. The beam pattern information comprises information indicative of (i) an elemental gain pattern in E_{Θ} and E_{Φ} polarizations, or in E and H planes, of at least one antenna element of the mobile device, or (ii) a boresight of the beam and a template beam pattern. As noted in the previously-described embodiments, the mobile device may provide information descriptive of the beam pattern of the beam in any of a variety of ways. According to some embodiments, the beam pattern information comprises information indicative of the elemental gain pattern and the information indicative of the elemental gain pattern further comprises gain values of the elemental gain pattern over a set of spatial angles. As noted, this may be provided by the mobile device using a 2D array. The angles for which gain values are provided may be configured by the mobile device with a separate device. As such, according to some embodiments, the method 800 may further comprise determining, with the mobile device, the set of spatial angles, or receiving, at the mobile device from the separate device, the set of spatial angles. Moreover, information may be frequency dependent. As such, according to some embodiments, the information indicative of the elemental gain pattern may comprise, for a plurality of frequencies peak gain, and beamwidth at one or more offset gain values from peak gain. Also, as previously indicated, in cases where the beam pattern information comprises information indicative of the elemental gain pattern, the information indicative of the elemental gain pattern may further comprise one or more beam weights used to form the beam, or an inter-antenna spacing of antenna elements of the mobile device, or a combination thereof.

As noted, embodiments may use a formula to relay information regarding an elemental gain pattern. Thus, according to some embodiments in which the beam pattern information comprises information indicative of the elemental gain pattern, the information indicative of the elemental gain pattern may further comprise one or more parameters of a parametric formula representative of the elemental gain pattern. In such instances, the method 800 may further comprise providing, from the mobile device to the separate device, the parametric formula. The one or more parameters of a parametric formula may be indicative of a plurality of frequencies, or a plurality of operating temperatures of the mobile device, or a combination thereof. Additionally or alternatively, the method 800 may further comprise providing, from the mobile device to the separate device, and indication of an error between the parametric formula and the true elemental gain pattern.

As previously noted, some embodiments may utilize beam pattern templates. Thus, according to some embodiments of the method 800, the beam pattern information may comprise information indicative of the template beam pattern, and the information indicative of the template beam pattern comprises an identifier of the template beam pattern. According to some embodiments, the method may further comprise sending, from the mobile device to the separate device, a plurality of template beam patterns.

The first and separate devices may vary depending on desired functionality. As noted, the mobile device may comprise a UE, and the separate device may comprise a network node that determines the location of the mobile device, based at least in part on the beam pattern information. As such, the separate device may comprise an LMF. Alternatively, according to some embodiments, the separate device may comprise an Enhanced Serving Mobile Location Center (E-SMLC), a Location Server Surrogate (which is a device co-located or embedded with a gNB/TRP that can provide LMF-like functionality), or a Transmission Reception Point (TRP) (e.g., a serving gNB of the UE).

Means for performing functionality at block 820 may comprise a wireless communication interface 930, bus 905, processing unit(s) 910, memory 960, and/or other components of a UE 105, as illustrated in FIG. 9.

FIG. 9 illustrates an embodiment of a UE 105, which can be utilized as described herein above (e.g., in association with FIGS. 1-8). It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 105 is shown comprising hardware elements that can be electrically coupled via a bus 905 (or may otherwise be in communication, as appropriate). The hardware elements may include a processing unit(s) 910 which can include without limitation one or more general-purpose processors, one or more special-purpose processors (such as DSP chips, graphics acceleration processors, application specific integrated circuits (ASICs), and/or the like), and/or other processing structures or means. As shown in FIG. 9, some embodiments may have a separate DSP 920, depending on desired functionality. Location determination and/or other determinations based on wireless communication may be provided in the processing unit(s) 910 and/or wireless communication interface 930 (discussed below). The UE 105 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 105 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. As such, the wireless communication interface 930 can include RF circuitry capable of forming Tx and/or Rx beams in the manner described in the embodiments herein. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. Cdma2000 is described in documents from a consortium named “3rd Generation Partnership Project 3” (3GPP2). 3GPP and 3GPP2 documents are publicly available. A WLAN may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 940. Sensors 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 910, DSP 920, and/or a processing unit within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 910 or DSP 920.

The UE 105 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 105 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 105 (and/or processing unit(s) 910 or DSP 920 within UE 105). In an aspect, then such code and/or instructions can be used to configure and/or adapt a general-purpose computer (or other device) to perform one or more operations in accordance with the described methods.

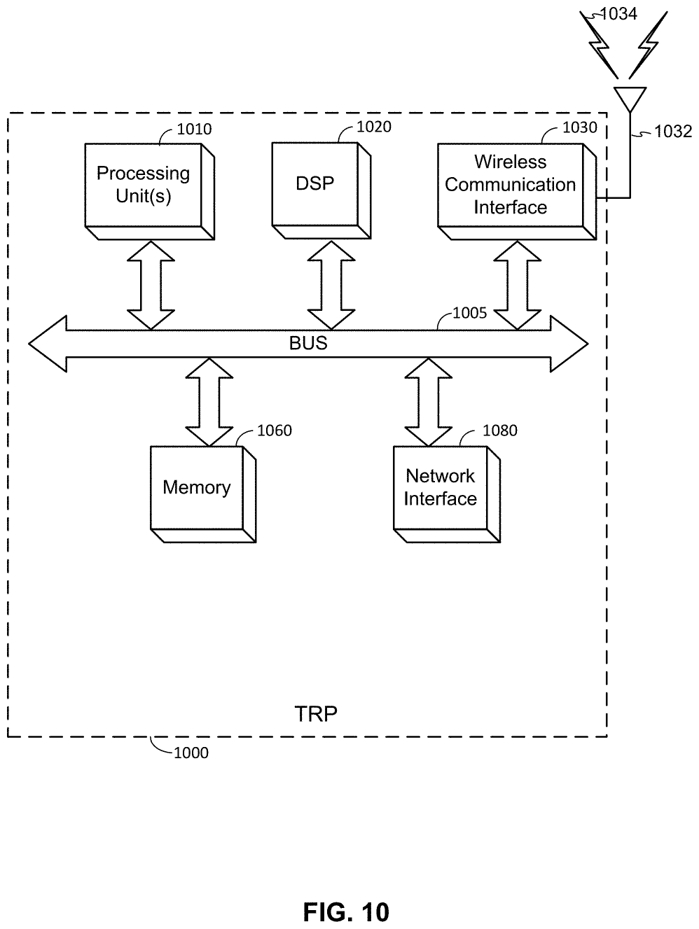

FIG. 10 illustrates an embodiment of a TRP 1000, which can be utilized as described herein above (e.g., in association with FIGS. 1-9) with regard to TRPs, gNBs, and/or base stations in general. As such, the TRP 1000 may correspond with a base station 120 of FIGS. 1 and 3-5, or a gNB 210 or ng-eNB 214 of FIG. 2. It should be noted that FIG. 10 is meant only to provide a generalized illustration of various components, any or all of which may be utilized as appropriate.

The TRP 1000 is shown comprising hardware elements that can be electrically coupled via a bus 1005 (or may otherwise be in communication, as appropriate). The hardware elements may include a processing unit(s) 1010 which can include without limitation one or more general-purpose processors, one or more special-purpose processors (such as DSP chips, graphics acceleration processors, ASICs, and/or the like), and/or other processing structure or means. As shown in FIG. 10, some embodiments may have a separate DSP 1020, depending on desired functionality. Location determination and/or other determinations based on wireless communication may be provided in the processing unit(s) 1010 and/or wireless communication interface 1030 (discussed below), according to some embodiments. The TRP 1000 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The TRP 1000 might also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the TRP 1000 to communicate as described herein. The wireless communication interface 1030 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1032 that send and/or receive wireless signals 1034.

The TRP 1000 may also include a network interface 1080, which can include support of wireline communication technologies. The network interface 1080 may include a modem, network card, chipset, and/or the like. The network interface 1080 may include one or more input and/or output communication interfaces to permit data to be exchanged with a network, communication network servers, computer systems, and/or any other electronic devices described herein.

In many embodiments, the TRP 1000 may further comprise a memory 1060. The memory 1060 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1060 of the TRP 1000 also may comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the TRP 1000 (and/or processing unit(s) 1010 or DSP 1020 within TRP 1000). In an aspect, then such code and/or instructions can be used to configure and/or adapt a general-purpose computer (or other device) to perform one or more operations in accordance with the described methods.

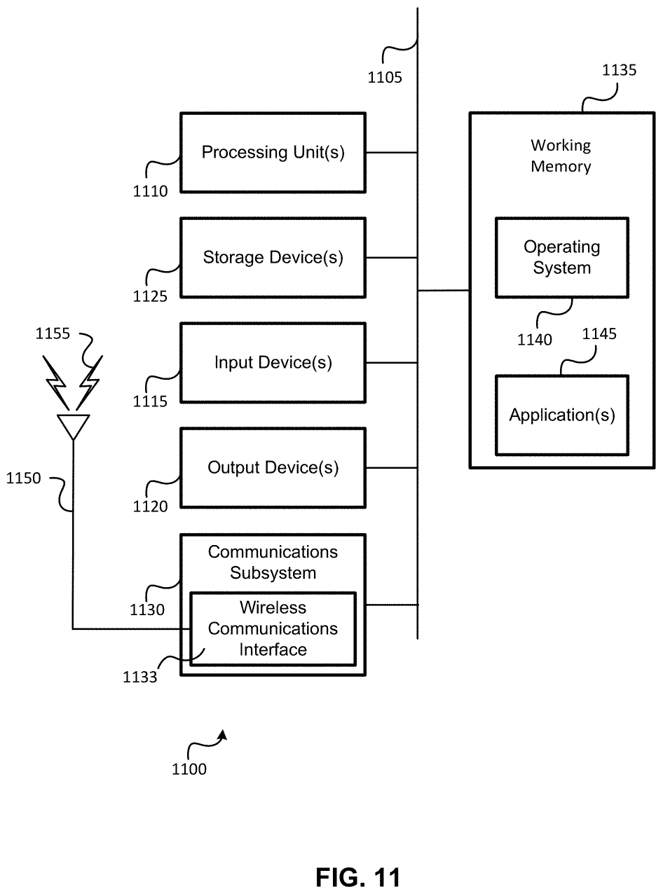

FIG. 11 is a block diagram of an embodiment of a computer system 1100, which may be used, in whole or in part, to provide the functions of one or more network components as described in the embodiments herein (e.g., location server 160 of FIG. 1, LMF 220 of FIG. 2, E-SMLC, etc.). It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner. In addition, it can be noted that components illustrated by FIG. 11 can be localized to a single device and/or distributed among various networked devices, which may be disposed at different geographical locations.

The computer system 1100 is shown comprising hardware elements that can be electrically coupled via a bus 1105 (or may otherwise be in communication, as appropriate). The hardware elements may include processing unit(s) 1110, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1100 also may comprise one or more input devices 1115, which may comprise without limitation a mouse, a keyboard, a camera, a microphone, and/or the like; and one or more output devices 1120, which may comprise without limitation a display device, a printer, and/or the like.

The computer system 1100 may further include (and/or be in communication with) one or more non-transitory storage devices 1125, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1100 may also include a communications subsystem 1130, which may comprise wireless communication technologies managed and controlled by a wireless communication interface 1133, as well as wired technologies (such as Ethernet, coaxial communications, universal serial bus (USB), and the like). The wireless communication interface 1133 may send and receive wireless signals 1155 (e.g., signals according to 5G NR or LTE) via wireless antenna(s) 1150. Thus the communications subsystem 1130 may comprise a modem, a network card (wireless or wired), an infrared communication device, a wireless communication device, and/or a chipset, and/or the like, which may enable the computer system 1100 to communicate on any or all of the communication networks described herein to any device on the respective network, including a User Equipment (UE), base stations and/or other TRPs, and/or any other electronic devices described herein. Hence, the communications subsystem 1130 may be used to receive and send data as described in the embodiments herein.

In many embodiments, the computer system 1100 will further comprise a working memory 1135, which may comprise a RAM or ROM device, as described above. Software elements, shown as being located within the working memory 1135, may comprise an operating system 1140, device drivers, executable libraries, and/or other code, such as one or more applications 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1125 described above. In some cases, the storage medium might be incorporated within a computer system, such as computer system 1100. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1. A method at a mobile device of providing beam pattern information of a beam used by a separate device for position determination of the mobile device, the method comprising: determining a use of the beam in a transmission or reception of a reference signal by the mobile device; and responsive to the determining the use of the beam, sending, from the mobile device to the separate device, the beam pattern information, wherein the beam pattern information comprises information indicative of: an elemental gain pattern in EΘ and EΦ polarizations, or in E and H planes, of at least one antenna element of the mobile device; or a boresight of the beam and a template beam pattern.
Clause 2. The method of clause 1, wherein the beam pattern information comprises information indicative of the elemental gain pattern, and the information indicative of the elemental gain pattern further comprises gain values of the elemental gain pattern over a set of spatial angles.
Clause 3. The method of clause 2 further comprising determining, with the mobile device, the set of spatial angles; or receiving, at the mobile device from the separate device, the set of spatial angles.
Clause 4. The method of any of clauses 2-3 wherein the information indicative of the elemental gain pattern comprises, for a plurality of frequencies: peak gain, and beamwidth at one or more offset gain values from the peak gain.
Clause 5. The method of any of clauses 1-4 wherein the beam pattern information comprises information indicative of the elemental gain pattern, and the information indicative of the elemental gain pattern further comprises one or more parameters of a parametric or functional formula representative of the elemental gain pattern.
Clause 6. The method of clause 5 further comprising providing, from the mobile device to the separate device, the parametric or functional formula.
Clause 7. The method of any of clauses 5-6 wherein the one or more parameters of the parametric or functional formula are indicative of: a plurality of frequencies, or a plurality of operating temperatures of the mobile device, or a combination thereof.
Clause 8. The method of any of clauses 5-7 further comprising providing, from the mobile device to the separate device, an indication of an error between the parametric or functional formula and a true elemental gain pattern.
Clause 9. The method of any of clauses 1-8 wherein the beam pattern information comprises information indicative of the elemental gain pattern, and the information indicative of the elemental gain pattern further comprises: one or more beam weights used to form the beam, or an inter-antenna spacing of antenna elements of the mobile device, or a combination thereof.
Clause 10. The method of any of clauses 1-9 wherein the beam pattern information comprises information indicative of the template beam pattern, and the information indicative of the template beam pattern comprises an identifier of the template beam pattern.
Clause 11. The method of any of clauses 1-10 wherein the beam pattern information comprises information indicative of the template beam pattern, and the method further comprises sending, from the mobile device to the separate device, a plurality of template beam patterns.
Clause 12. The method of any of clauses 1-11 wherein the mobile device comprises a User Equipment (UE).
Clause 13. The method of any of clauses 1-12 wherein the separate device comprises a network node that determines a location of the mobile device based, at least in part, on the beam pattern information.
Clause 14. The method clause 13 wherein the network node comprises: a Location Management Function (LMF), an Enhanced Serving Mobile Location Center (E-SMLC), a Location Server Surrogate, or a Transmission Reception Point (TRP).
Clause 15. The method of any of clauses 13-14 wherein the network node determines the location of the mobile device further based on determining an Angle-of-Arrival (AOA) based on the beam pattern information.
Clause 16. A mobile device for providing beam pattern information of a beam used by a separate device for position determination of the mobile device, the mobile device comprising: a transceiver; a memory; and one or more processors communicatively coupled with the transceiver and the memory, wherein the one or more processors are configured to: determine a use of the beam in a transmission or reception of a reference signal by the mobile device; and responsive to the determining the use of the beam, sending, via the transceiver to the separate device, the beam pattern information, wherein the beam pattern information comprises information indicative of: an elemental gain pattern in EΘ and EΦ polarizations, or in E and H planes, of at least one antenna element of the mobile device; or a boresight of the beam and a template beam pattern.
Clause 17. The mobile device of clause 16, wherein the one or more processors are configured to include, in the elemental gain pattern, gain values of the elemental gain pattern over a set of spatial angles.
Clause 18. The mobile device of clause 17 wherein the one or more processors are further configured to: determine the set of spatial angles; or receive, at the mobile device from the separate device, the set of spatial angles.
Clause 19. The mobile device of any of clauses 17-18 wherein the one or more processors are configured to include, in the information indicative of the elemental gain pattern, for a plurality of frequencies: peak gain, and beamwidth at one or more offset gain values from the peak gain.
Clause 20. The mobile device of any of clauses 16-19 wherein the one or more processors are configured to include, in the information indicative of the elemental gain pattern, one or more parameters of a parametric or functional formula representative of the elemental gain pattern.
Clause 21. The mobile device of clause 20 wherein the one or more processors are further configured to provide, to the separate device via the transceiver, the parametric or functional formula.
Clause 22. The mobile device of any of clauses 20-21 wherein the one or more processors are further configured to provide, to the separate device via the transceiver, an indication of an error between the parametric or functional formula and a true elemental gain pattern.
Clause 23. The mobile device of any of clauses 16-22 wherein the one or more processors are configured to include, in the information indicative of the elemental gain pattern: one or more beam weights used to form the beam, or an inter-antenna spacing of antenna elements of the mobile device, or a combination thereof.
Clause 24. The mobile device of any of clauses 16-23 wherein the one or more processors are configured to include, in the information indicative of the template beam pattern, an identifier of the template beam pattern.
Clause 25. The mobile device of any of clauses 16-24 wherein the one or more processors are configured to send, from the mobile device to the separate device, a plurality of template beam patterns.
Clause 26. The mobile device of any of clauses 16-25 wherein the mobile device comprises a User Equipment (UE).
Clause 27. The mobile device of any of clauses 16-26 wherein, to send the beam pattern information to the separate device, the one or more processors are configured to send the beam pattern information to a network node that determines a location of the mobile device based, at least in part, on the beam pattern information.
Clause 28. The mobile device of any of clauses 16-27 wherein the one or more processors are configured to determine the location of the mobile device further based on determining an Angle-of-Arrival (AOA) based on the beam pattern information.
Clause 29. An apparatus having means for performing the method of any one of clauses 1-15.
Clause 30. A non-transitory computer-readable medium storing instructions comprising code for performing the method of any one of clauses 1-15.

What is claimed is:

1. A method at a mobile device of providing beam pattern information of a beam used by a separate device for position determination of the mobile device, the method comprising:
determining a use of the beam in a transmission or reception of a reference signal by the mobile device; and
responsive to the determining the use of the beam, sending, from the mobile device to the separate device, the beam pattern information, wherein the beam pattern information comprises information indicative of:
(i) an elemental gain pattern in E_{Θ} and E_{Φ} polarizations, or in E and H planes, of at least one antenna element of the mobile device; or
(ii) a boresight of the beam and a template beam pattern.

2. The method of claim 1, wherein the beam pattern information comprises information indicative of the elemental gain pattern, and the information indicative of the elemental gain pattern further comprises gain values of the elemental gain pattern over a set of spatial angles.

3. The method of claim 2, further comprising:
determining, with the mobile device, the set of spatial angles; or
receiving, at the mobile device from the separate device, the set of spatial angles.

4. The method of claim 2, wherein the information indicative of the elemental gain pattern comprises, for a plurality of frequencies:
peak gain, and
beamwidth at one or more offset gain values from the peak gain.

5. The method of claim 1, wherein the beam pattern information comprises information indicative of the elemental gain pattern, and the information indicative of the elemental gain pattern further comprises one or more parameters of a parametric or functional formula representative of the elemental gain pattern.

6. The method of claim 5, further comprising providing, from the mobile device to the separate device, the parametric or functional formula.

7. The method of claim 5, wherein the one or more parameters of the parametric or functional formula are indicative of:
a plurality of frequencies, or
a plurality of operating temperatures of the mobile device, or
a combination thereof.

8. The method of claim 5, further comprising providing, from the mobile device to the separate device, an indication of an error between the parametric or functional formula and a true elemental gain pattern.

9. The method of claim 1, wherein the beam pattern information comprises information indicative of the elemental gain pattern, and the information indicative of the elemental gain pattern further comprises:
one or more beam weights used to form the beam, or
an inter-antenna spacing of antenna elements of the mobile device, or
a combination thereof.

10. The method of claim 1, wherein the beam pattern information comprises information indicative of the template beam pattern, and the information indicative of the template beam pattern comprises an identifier of the template beam pattern.

11. The method of claim 1, wherein the beam pattern information comprises information indicative of the template beam pattern, and the method further comprises sending, from the mobile device to the separate device, a plurality of template beam patterns.

12. The method of claim 1, wherein the mobile device comprises a User Equipment (UE).

13. The method of claim 1, wherein the separate device comprises a network node that determines a location of the mobile device based, at least in part, on the beam pattern information.

14. The method of claim 13, wherein the network node comprises:
a Location Management Function (LMF),
an Enhanced Serving Mobile Location Center (E-SMLC),
a Location Server Surrogate, or
a Transmission Reception Point (TRP).

15. The method of claim 13, wherein the network node determines the location of the mobile device further based on determining an Angle-of-Arrival (AOA) based on the beam pattern information.

16. A mobile device for providing beam pattern information of a beam used by a separate device for position determination of the mobile device, the mobile device comprising:
a transceiver;
a memory; and
one or more processors communicatively coupled with the transceiver and the memory, wherein the one or more processors are configured to:
determine a use of the beam in a transmission or reception of a reference signal by the mobile device; and
responsive to the determining the use of the beam, sending, via the transceiver to the separate device, the beam pattern information, wherein the beam pattern information comprises information indicative of:
an elemental gain pattern in E_{Θ} and E_{Φ} polarizations, or in E and H planes, of at least one antenna element of the mobile device; or
a boresight of the beam and a template beam pattern.

17. The mobile device of claim 16, wherein the one or more processors are configured to include, in the elemental gain pattern, gain values of the elemental gain pattern over a set of spatial angles.

18. The mobile device of claim 17, wherein the one or more processors are further configured to:
determine the set of spatial angles; or
receive, at the mobile device from the separate device, the set of spatial angles.

19. The mobile device of claim 17, wherein the one or more processors are configured to include, in the information indicative of the elemental gain pattern, for a plurality of frequencies:
peak gain, and
beamwidth at one or more offset gain values from the peak gain.

20. The mobile device of claim 16, wherein the one or more processors are configured to include, in the information indicative of the elemental gain pattern, one or more parameters of a parametric or functional formula representative of the elemental gain pattern.

21. The mobile device of claim 20, wherein the one or more processors are further configured to provide, to the separate device via the transceiver, the parametric or functional formula.

22. The mobile device of claim 20, wherein the one or more processors are further configured to provide, to the separate device via the transceiver, an indication of an error between the parametric or functional formula and a true elemental gain pattern.

23. The mobile device of claim 16, wherein the one or more processors are configured to include, in the information indicative of the elemental gain pattern:
one or more beam weights used to form the beam, or
an inter-antenna spacing of antenna elements of the mobile device, or
a combination thereof.

24. The mobile device of claim 16, wherein the one or more processors are configured to include, in the information indicative of the template beam pattern, an identifier of the template beam pattern.

25. The mobile device of claim 16, wherein the one or more processors are configured to send, from the mobile device to the separate device, a plurality of template beam patterns.

26. The mobile device of claim 16, wherein the mobile device comprises a User Equipment (UE).

27. The mobile device of claim 16, wherein, to send the beam pattern information to the separate device, the one or more processors are configured to send the beam pattern information to a network node that determines a location of the mobile device based, at least in part, on the beam pattern information.

28. The mobile device of claim 27, wherein the one or more processors are configured to determine the location of the mobile device further based on determining an Angle-of-Arrival (AOA) based on the beam pattern information.

29. An apparatus for providing beam pattern information of a beam used by a separate device for position determination of the apparatus, the apparatus comprising:
means for determining a use of the beam in a transmission or reception of a reference signal by the apparatus; and
means for responsive to the determining the use of the beam, sending, from the apparatus to the separate device, the beam pattern information, wherein the beam pattern information comprises information indicative of:
an elemental gain pattern in E_{Θ} and E_{Φ} polarizations, or in E and H planes, of at least one antenna element of the apparatus; or
a boresight of the beam and a template beam pattern.

30. A non-transitory computer-readable medium storing instructions for providing beam pattern information of a beam used by a separate device for position determination of a mobile device, the instructions comprising code for:
determining a use of the beam in a transmission or reception of a reference signal by the mobile device; and
responsive to the determining the use of the beam, sending, from the mobile device to the separate device, the beam pattern information, wherein the beam pattern information comprises information indicative of:
an elemental gain pattern in E_{Θ} and E_{Φ} polarizations, or in E and H planes, of at least one antenna element of the mobile device; or
a boresight of the beam and a template beam pattern.
